(19) United States
(12) Patent Application Publication
(10) Pub. No.: US 2025/0378686 A1
(43) Pub. Date: Dec. 11, 2025

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Junichi KAMIMURA, Tokyo (JP)

(73) Assignee: NEC Corporation, Minato-ku, Tokyo (JP)

(21) Appl. No.: 18/874,615

(22) PCT Filed: Jun. 22, 2022
(86) PCT No.: PCT/JP2022/024924

§ 371 Date: Dec. 13, 2024

(51) Int. Cl. G06V 10/98; G06V 20/52; G06V 40/16

(52) U.S. Cl. CPC G06V 10/98; G06V 20/52; G06V 40/161; G06V 40/168; G06V 40/172

(57) ABSTRACT

An information processing apparatus includes: an acquisition unit that acquires biometric information on a user located in an authentication area; an authentication unit that performs authentication processing based on the biometric information; an authentication difficulty degree determination unit that determines an authentication difficulty degree indicating a possibility that the user reaches outside the authentication area without completing the authentication processing; and an output timing determination unit that determines output timing of a result of the authentication processing in accordance with the authentication difficulty degree. According to such an information processing apparatus, it is possible to output the authentication result at appropriate timing.

### TECHNICAL FIELD

This disclosure relates to technical fields of an information processing apparatus, an information processing system, an information processing method, and a recording medium.

### BACKGROUND ART

A known apparatus of this type manages entry and exit of a user by using biometric authentication. For example, Patent Literature 1 discloses that authentication processing of a plurality of visitors is collectively performed. Patent Literature 2 discloses that face authentication is performed on an authentication target person walking in a monitoring area and a result is projected in a projection area. Patent Literature 3 discloses that as a user's moving velocity is higher, output timing of an unlock signal is earlier, in a face authentication system that manages entry and exit.

### CITATION LIST

### Patent Literature

Patent Literature 1: International Publication No. WO2022/003853
Patent Literature 2: International Publication No. WO 2021/199234
Patent Literature 3: International Publication No. WO 2021/006260

### SUMMARY

### Technical Problem

This disclosure aims to improve the techniques/technologies disclosed in Citation List.

### Solution to Problem

An information processing apparatus according to an example aspect of this disclosure includes: an acquisition unit that acquires biometric information on a user located in an authentication area; an authentication unit that performs authentication processing based on the biometric information; an authentication difficulty degree determination unit that determines an authentication difficulty degree indicating a possibility that the user reaches outside the authentication area without completing the authentication processing; and an output timing determination unit that determines output timing of a result of the authentication processing in accordance with the authentication difficulty degree.

An information processing system according to an example aspect of this disclosure includes: an acquisition unit that acquires biometric information on a user located in an authentication area; an authentication unit that performs authentication processing based on the biometric information; an authentication difficulty degree determination unit that determines an authentication difficulty degree indicating a possibility that the user reaches outside the authentication area without completing the authentication processing; and an output timing determination unit that determines output timing of a result of the authentication processing in accordance with the authentication difficulty degree.

An information processing method according to an example aspect of this disclosure includes: acquiring biometric information on a user located in an authentication area; performing authentication processing based on the biometric information; determining an authentication difficulty degree indicating a possibility that the user reaches outside the authentication area without completing the authentication processing; and determining output timing of a result of the authentication processing in accordance with the authentication difficulty degree.

A recording medium according to an example aspect of this disclosure is a recording medium on which a computer program that allows at least one computer to execute an information processing method is recorded, the information processing method including: acquiring biometric information on a user located in an authentication area; performing authentication processing based on the biometric information; determining an authentication difficulty degree indicating a possibility that the user reaches outside the authentication area without completing the authentication processing; and determining output timing of a result of the authentication processing in accordance with the authentication difficulty degree.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a plan view illustrating a display example of an authentication result by the information processing apparatus according to the first example embodiment.

FIG. 5 is a flowchart illustrating a flow of an operation of displaying the authentication result by the information processing apparatus according to the first example embodiment.

FIG. 6 is a flowchart illustrating a flow of operation of an information processing apparatus according to a second example embodiment.

FIG. 7 is a flowchart illustrating a flow of operation of an information processing apparatus according to a third example embodiment.

FIG. 8 is a flowchart illustrating a flow of operation of an information processing apparatus according to a fourth example embodiment.

FIG. 9 is a flowchart illustrating a flow of operation of an information processing apparatus according to a fifth example embodiment.

FIG. 10 is a flowchart illustrating a flow of operation of an information processing apparatus according to a sixth example embodiment.

FIG. 11 is a flowchart illustrating a flow of operation of an information processing apparatus according to a seventh example embodiment.

FIG. 12 is a block diagram illustrating a functional configuration of an information processing apparatus according to an eighth example embodiment.

FIG. 13 is a flowchart illustrating a flow of operation of the information processing apparatus according to the eighth example embodiment.

FIG. 14 is a flowchart illustrating a flow of operation of an information processing apparatus according a ninth example embodiment.

### DESCRIPTION OF EXAMPLE EMBODIMENTS

Hereinafter, an information processing apparatus, an information processing system, an information processing method, and a recording medium according to example embodiments will be described with reference to the drawings.

### First Example Embodiment

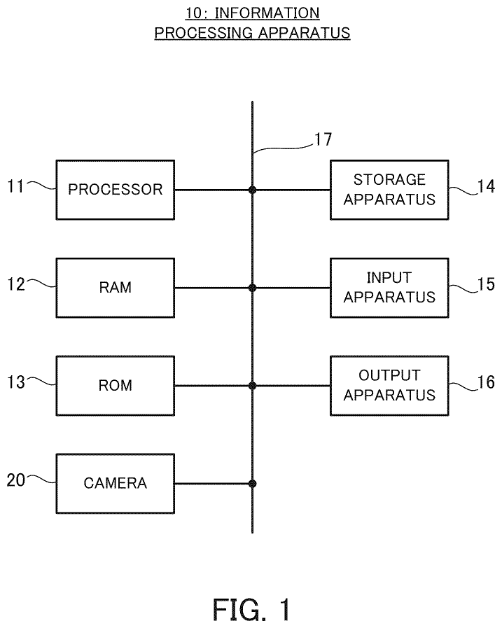

An information processing apparatus according to a first example embodiment will be described with reference to FIG. 1 to FIG. 5.

### (Hardware Configuration)

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15, an output apparatus 16, and a camera 20. The processor 11, the RAM 12, the ROM 13, the storage apparatus 14, the input apparatus 15, the output apparatus 16, and the camera 20 are connected via a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 10, via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing biometric authentication and outputting an authentication result is realized or implemented in the processor 11. That is, the processor 11 may function as a controller for executing each control in the information processing apparatus 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used instead of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM 13.

The storage apparatus 14 stores data that are stored by the information processing apparatus 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet. The output apparatus 16 may be configured as an apparatus that performs projection mapping. The output apparatus 16 may be an apparatus that outputs information in a form other than an image. For example, the output apparatus 16 may be a speaker that audio-outputs the information about the information processing apparatus 10.

The camera 20 is configured to capture an image in an authentication area. Here, the “authentication area” is an area in which authentication processing is performed on a user, and is set before a restricted area in which only the user who has succeeded in the authentication processing is allowed to enter, for example. The camera 20 captures an image of the user attempting to enter the restricted area through the authentication area, for example. The image captured by the camera 20 is used to acquire biometric information on the user. As described above, the camera 20 may be configured to be used in a technique/technology of managing entry, exit, and passage of the user by the authentication processing (biometric authentication). A plurality of cameras 20 may be provided. In addition, another sensor or the like that may acquire the biometric information on the user, may be disposed, in addition to or in place of the camera 20.

Although FIG. 1 illustrates the information processing apparatus 10 including a plurality of apparatuses, all or a part of the functions may be realized or implemented in a single apparatus. In such a case, the information processing apparatus may include, for example, only the processor 11, the RAM 12, and the ROM 13. The other components (i.e., the storage apparatus 14, the input apparatus 15, the output apparatus 16, and the camera 20) may be provided in an external apparatus connected to the information processing apparatus. In addition, in the information processing apparatus, a part of an arithmetic function may be realized by an external apparatus (e.g., an external server or cloud, etc.).

### (Functional Configuration)

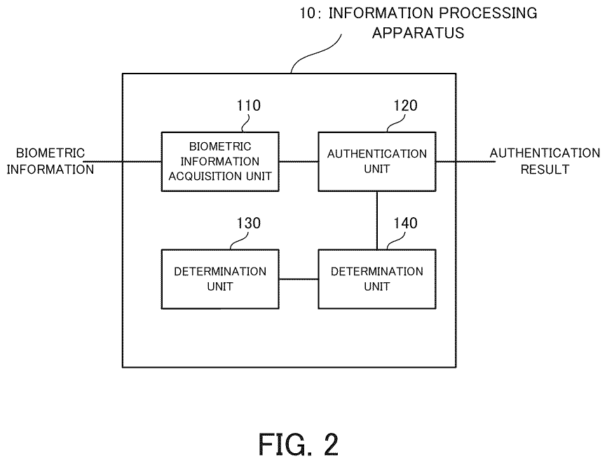

Next, a functional configuration of the information processing apparatus 10 according to the first example embodiment will be described with reference to FIG. 2. FIG. 2 is a block diagram illustrating the functional configuration of the information processing apparatus according to the first example embodiment.

As illustrated in FIG. 2, the information processing apparatus 10 according to the first example embodiment includes, as components for realizing the functions thereof, a biometric information acquisition unit 110, an authentication unit 120, a determination unit 130, and a determination unit 140. Each of the biometric information acquisition unit 110, the authentication unit 120, the determination unit 130, and the determination unit 140 may be a processing block realized or implemented by the processor 11 (see FIG. 1), for example.

The biometric information acquisition unit 110 is configured to acquire the biometric information on the user located in the authentication area. The biometric information acquisition unit 110 may be configured to acquire the biometric information on the user, from the image in the authentication area captured by the camera 20 (see FIG. 1). For example, the biometric information acquisition unit 110 may be configured to detect a face of the user from image in the authentication area and acquire a feature quantity of the user's face. In addition, the biometric information acquisition unit 110 may be configured to keep acquiring the biometric information, periodically, by tracking the detected user in the authentication area. When there are a plurality of users in the authentication area, the biometric information acquisition unit 110 may be configured to acquire the biometric information on each of the plurality of users. The biometric information acquired by the biometric information acquisition unit 110 is configured to be outputted to the authentication unit 120

The authentication unit 120 is configured to perform the authentication processing (i.e., biometric authentication), based on the biometric information on the user acquired by the biometric information acquisition unit 110. For example, the authentication unit 120 may be configured to perform face authentication by collating/verifying the feature quantity of the user's face acquired by the biometric information acquisition unit 110 with the feature quantity of a face of a registered user registered in advance. When the biometric information on a plurality of users is acquired by the acquisition unit 110, the authentication unit 120 may perform the authentication processing on each of the plurality of users. The authentication unit 120 is configured to output a result of the authentication processing (hereinafter referred to as an “authentication result” as appropriate) via the output apparatus 16 (see FIG. 1), for example. Timing at which the authentication unit 120 outputs the authentication result, is configured to be determined by the determination unit 140 described later.

The determination unit 130 is configured to determine an authentication difficulty degree. The “authentication difficulty degree” here is determined to be a degree indicating a possibility that the user located in the authentication area may reach outside the authentication area without completing the authentication processing. The determination unit 130 may determine the authentication difficulty degree by using various types of information, in addition to the image captured by the camera 20, for example. A specific example of information used by the determination unit 130 to determine the authentication difficulty degree (hereinafter referred to as a “determination element” as appropriate) will be described in detail in another example embodiment later. Information about the authentication difficulty degree determined by the determination unit 130 is configured to be outputted to the determination unit 140.

The determination unit 140 is configured to determine output timing of the authentication result by the authentication unit 120, in accordance with the authentication difficulty degree determined by the determination unit 130. For example, the determination unit 140 may set the output timing early when the authentication difficulty degree is high (i.e., when the user is likely to reach outside the authentication area without completing the authentication processing), and may set the output timing slow when the authentication difficulty degree is low (i.e., when the user is unlikely to reach outside the authentication area without completing the authentication processing). The determination unit 140 may be configured to determine only the output timing of a particular authentication result. For example, the determination unit 140 may be configured not to determine the output timing of the authentication result when the authentication processing is successful, and to determine the output timing of the authentication result when the authentication processing is failed (e.g., timing of outputting an alert).

### (Flow of Operation)

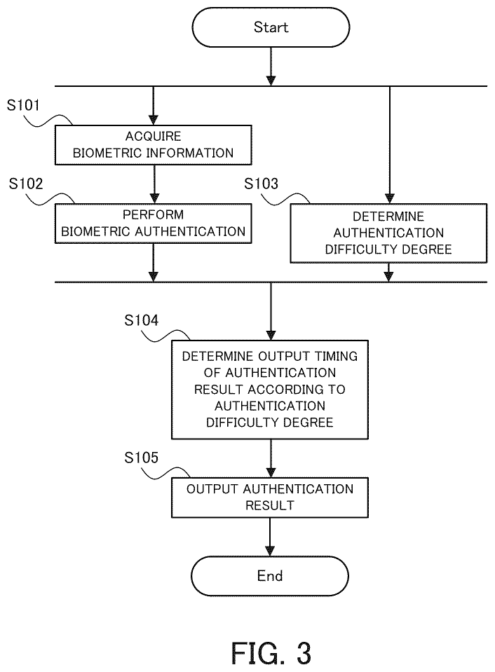

Next, with reference to FIG. 3, a flow of overall operation by the information processing apparatus 10 according to the first example embodiment will be described. FIG. 3 is a flowchart illustrating the flow of the operation of the information processing apparatus according to the first example embodiment.

As illustrated in FIG. 3, when the operation of the information processing apparatus 10 according to the first example embodiment is started, first, the biometric information acquisition unit 110 acquires the biometric information on the user located in the authentication area (step S101). Then, the authentication unit 120 performs the authentication processing by using the biometric information acquired by the biometric information acquisition unit 110 (step S102). Meanwhile, the determination unit 130 determines the authentication difficulty degree (step S103).

Subsequently, the determination unit 140 determines the output timing of the authentication result, based on the authentication difficulty degree determined by the determination unit 130 (step S104). The authentication unit 120 outputs the authentication result at the output timing determined by the determination unit 140 (step S105).

### (Output Example of Authentication Result)

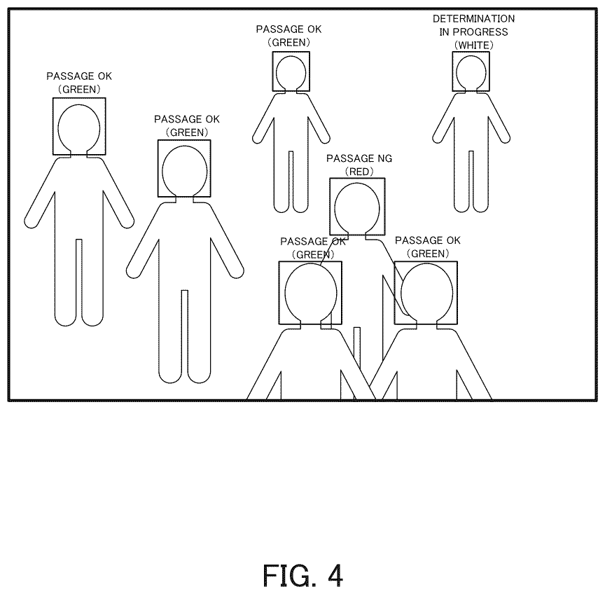

Next, with reference to FIG. 4, an output example by the information processing apparatus according to the first example embodiment (here, a display example by a display) will be specifically described. FIG. 4 is a plan view illustrating a display example of the authentication result by the information processing apparatus according to the first example embodiment. FIG. 4 exemplifies that the face authentication is performed on the user walking from a rear side to a front side in the drawing.

As illustrated in FIG. 4, in the information processing apparatus 10 according to the first example embodiment, the authentication result may be displayed to be superimposed on the image in the authentication area captured by the camera 20. For example, the authentication result may be indicated by a rectangle displayed to surround the user's face in the image. Here, the rectangles displayed in the image are displayed in different colors depending on a state of progress of the authentication processing. Specifically, for the user who has succeeded in the authentication processing, passage OK is determined and a green rectangle is displayed. For the user who has failed in the authentication processing, passage NG is determined and a red rectangle is displayed. For the user who is being authenticated (i.e. the user who has not yet succeeded in the authentication, but has not yet been determined to fail in the authentication), a white rectangle is displayed.

For example, when the user enters an angle of field of the camera 20, the user's face is firstly detected and a white rectangle is displayed on the detected user's face. Then, for the user who has succeeded in the face authentication, the color of the rectangle changes from white (determination in progress) to green (passage OK). Such a user is permitted to pass through the authentication area and then enter the restricted area. On the other hand, for the user who has failed in the face authentication, the color of the rectangle changes from white (determination in progress) to red (passage NG). Such a user should be prohibited from entering the restricted area. Therefore, for the user with the red rectangle displayed, it is required to take actions such as restricting entry. This action may be taken, for example, by an observer/monitoring person monitoring the authentication result, or the like.

### (Display Operation)

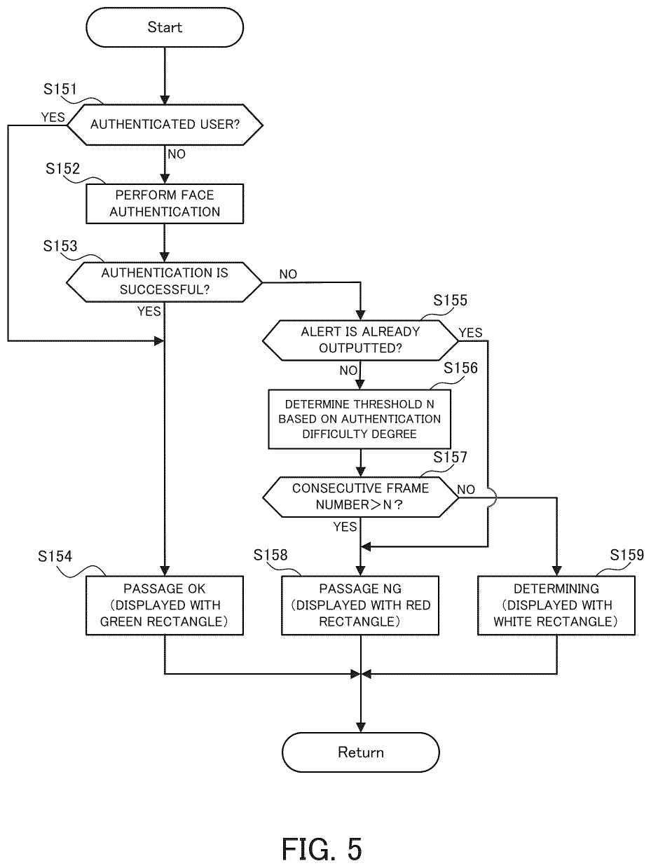

Next, with reference to FIG. 5, a description will be given to an operation when outputting the display example described above. FIG. 5 is a flowchart illustrating a flow of the operation of displaying the authentication result by the information processing apparatus according to the first example embodiment.

As illustrated in FIG. 5, in the information processing apparatus 10 according to the first example embodiment, first, the authentication unit 120 determines whether or not the user who is an authentication target is an authenticated user (i.e., the user who has succeeded in the authentication) (step S151). Whether or not the user is an authenticated user, may be determined by storing a person ID corresponding to the user who has succeeded in the authentication, for example.

When the user who is an authentication target is an authenticated user (the step S151: YES), the authentication unit 120 continuously displays passage OK (i.e., the green rectangle) as the authentication result (step S154). On the other hand, when the user who is an authentication target is not the authenticated user (the step S151: NO), the authentication unit 120 performs the face authentication (step S152). Then, when the face authentication is successful (the step S153: YES), the authentication unit 120 displays passage OK (i.e., the green rectangle) as the authentication result (step S154).

On the other hand, when the face authentication is not successful (the step S153: NO), the authentication unit 120 determines whether or not an alert is already outputted (i.e., whether or not the red rectangle is displayed) (step S155). When the alert is already outputted (the step S155: YES), the authentication unit 120 continuously displays passage NG (i.e., the red rectangle) as the authentication result (step S158). On the other hand, when the alert is not yet outputted (the step S155: NO), the determination unit 140 determines a threshold N, based on the authentication difficulty degree. The “threshold N” here is a threshold set to determine display timing of the authentication result (specifically, the red rectangle indicating a failure in the authentication), and N has a value corresponding to the number of frames of the image captured by the camera 20. The threshold N is determined to have a smaller value as the authentication difficulty degree is higher, for example.

When the threshold N is determined, the authentication unit 120 determines whether or not the number of frames acquired in a state in which the authentication is not successful (hereinafter referred to as “consecutive frame number” as appropriate) exceeds the threshold N (step S157). When the consecutive frame number exceeds N (the step S157: YES), the authentication unit 120 displays passage NG (i.e., the red rectangle) as the authentication result (step S158). On the other hand, when the consecutive frame number does not exceed N (the step S157: NO), the authentication unit 120 displays the white rectangle indicating that the determination is in progress (step S159).

The above-described series of processing steps is repeatedly performed, for example, every time one frame of the image is acquired. This changes the color of the rectangle from white to green for the user who has succeeded in the authentication, and changes the color of the rectangle from white to red for the user who has failed in the authentication. Especially in the present example embodiment, the timing of displaying the red rectangle is changed in accordance with the threshold N. Consequently, the output timing of the authentication result is changed in accordance with the authentication difficulty degree.

### (Technical Effect)

Next, a technical effect obtained by the information processing apparatus 10 according to the first example embodiment will be described.

As described in FIG. 1 to FIG. 5, in the information processing apparatus 10 according to the first example embodiment, the output timing of the authentication result is determined based on the authentication difficulty degree. In this way, it is possible to output the authentication result of each user at appropriate timing. As a consequence, it is possible to avoid missing the user who reaches outside the authentication area without completing the authentication processing. For example, for the user with a high authentication difficulty degree (i.e., who is hardly authenticated), the output timing of the authentication results is determined to be advanced, and the alert is thus outputted early. This makes it possible to properly discover the user who should not be permitted to pass through the authentication area. On the other hand, for the user with a low authentication difficulty degree (i.e., who is easily authenticated), the output timing of the authentication results is determined to be delayed, and thus, the authentication processing is performed for a sufficient amount of time and the alert is then outputted. This may prevent an unnecessary alert, thereby finding the user who should not be permitted to pass through the authentication area.

### Second Example Embodiment

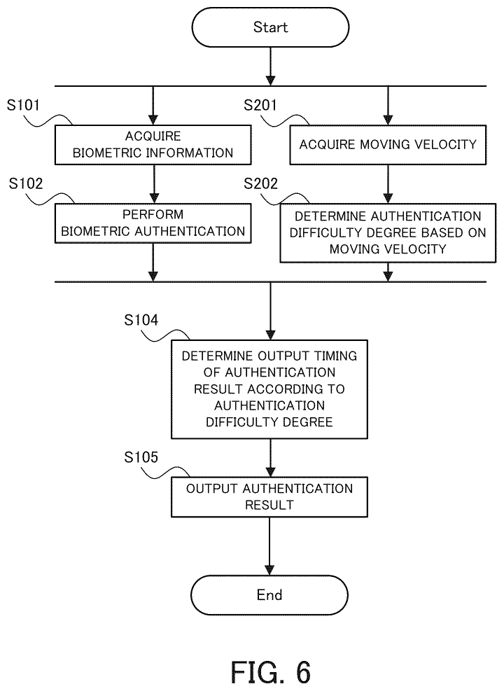

The information processing apparatus 10 according to a second example embodiment will be described with reference to FIG. 6. The second example embodiment describes a specific example of the determination element for determining the authentication difficulty degree, and may be the same as the first example embodiment in the other parts. For this reason, a part that is different from the first example embodiment will be described in detail below, and a description of the other overlapping parts will be omitted as appropriate.

### (Flow of Operation)

First, with reference to FIG. 6, a flow of overall operation by the information processing apparatus 10 according to the second example embodiment will be described. FIG. 6 is a flowchart illustrating the flow of the operations of the information processing apparatus according to the second example embodiment. In FIG. 6, the same processing steps as those illustrated in FIG. 3 carry the same reference numerals.

As illustrated in FIG. 6, when the operation of the information processing apparatus 10 according to the second example embodiment starts, first, the biometric information acquisition unit 110 acquires the biometric information on the user located in the authentication area (step S101). Then, the authentication unit 120 performs the authentication processing by using the biometric information acquired by the biometric information acquisition unit 110 (step S102).

Meanwhile, the determination unit 130 acquires information about a moving velocity of the user, as the determination element for determining the authentication difficulty degree (step 201). For example, the determination unit 130 may acquire the moving velocity of the user from the image captured by the camera 20 (e.g., a difference of a user position in consecutive frames). Alternatively, the determination unit 130 may acquire the moving velocity of the user by using another unit such as a velocity sensor.

Subsequently, the determination unit 130 determines the authentication difficulty degree by using the acquired information about the moving velocity of the user (step S202). For example, the determination unit 130 may determine that the user whose moving velocity is high, quickly passes through the authentication area (in other words, a time of allowing the authentication is short), and may set a high authentication difficulty degree. Furthermore, the determination unit 130 may determine that the user whose moving velocity is low or is stopped, has a long time to stay in the authentication area (in other words, a time of performing the authentication processing is long), and may set a low authentication difficulty degree.

Subsequently, the determination unit 140 determines the output timing of the authentication result, based on the authentication difficulty degree determined by the determination unit 130 (step S104). Then, the authentication unit 120 outputs the authentication result at the output timing determined by the determination unit 140 (step S105).

### (Technical Effect)

Next, a technical effect obtained by the information processing apparatus 10 according to the second example embodiment will be described.

As described in FIG. 6, in the information processing apparatus 10 according to the second example embodiment, the authentication difficulty degree is determined based on the moving velocity of the user. In this way, since the user who is likely to quickly pass through the authentication area or stays in the authentication area for a long time, can be accurately determined, for example, it is possible to properly determine the authentication difficulty degree. Therefore, it is possible to output the authentication result at appropriate timing.

### Third Example Embodiment

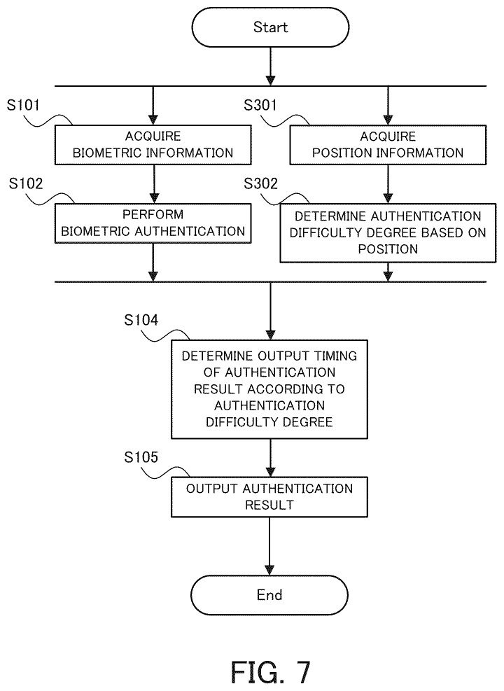

The information processing apparatus 10 according to a third example embodiment will be described with reference to FIG. 7. The third example embodiment describes a specific example of the determination element as in the second example embodiment, and may be the same as the first and second example embodiments in the other parts. For this reason, a part that is different from each of the example embodiments described above will be described in detail below, and a description of the other overlapping parts will be omitted as appropriate.

### (Flow of Operation)

First, with reference to FIG. 7, a flow of overall operation by the information processing apparatus 10 according to the third example embodiment will be described. FIG. 7. is a flowchart illustrating the flow of the operation of the information processing apparatus according to the third example embodiment. In FIG. 7, the same processing steps as those illustrated in FIG. 3 carry the same reference numerals.

As illustrated in FIG. 7, when the operation of the information processing apparatus 10 according to the third example embodiment is started, first, the biometric information acquisition unit 110 acquires the biometric information on the user located in the authentication area (step S101). Then, the authentication unit 120 performs the authentication processing by using the biometric information acquired by the biometric information acquisition unit 110 (step S102).

Meanwhile, the determination unit 130 acquires information about the position of the user as the determination element for determining authentication difficulty degree (step 301). For example, the determination unit 130 may acquire the position of the user in the authentication area from the image captured by the camera 20 (i.e., the position of the user in an angle of view of the camera 20). Alternatively, the determination unit 130 may acquire the moving velocity of the user by using another unit such as a position sensor.

Subsequently, the determination unit 130 determines the authentication difficulty degree by using the acquired information about the position of the user (step S302). For example, the determination unit 130 may determine that the user located on an exit side of the authentication area, leaves the authentication area soon (in other words, a time of allowing the authentication is short), and may set a high authentication difficulty degree. Furthermore, the determination unit 130 may determine that the user located on an entrance side of the authentication area, stays in the authentication area for a while (in other words, a time of performing the authentication processing is long), and may set a low authentication difficulty degree.

Subsequently, the determination unit 140 determines the output timing of the authentication result, based on the authentication difficulty degree determined by the determination unit 130 (step S104). Then, the authentication unit 120 outputs the authentication result at the output timing determined by the determination unit 140 (step S105).

### (Technical Effect)

Next, a technical effect obtained by the information processing apparatus 10 according to the third example embodiment will be described.

As described in FIG. 7, in the information processing apparatus 10 according to the third example embodiment, the authentication difficulty degree is determined based on the position of the user. In this way, since the user who is likely to leave the authentication area soon or stay in the authentication area for a long time, can be accurately determined, for example, it is possible to properly determine the authentication difficulty degree. Therefore, it is possible to output the authentication result at appropriate timing.

The authentication difficulty degree may be determined based on both the moving velocity of the user described in the second example embodiment and the position of the user described in the third example embodiment. In this case, after determining each of the authentication difficulty degree based on the moving velocity of the user and the authentication difficulty degree based on the position of the user, either one (e.g., a higher one) may be selected. Alternatively, one authentication difficulty degree may be determined by comprehensively considering the moving velocity and the position of the user. Thus, the authentication difficulty degree may be determined based on a plurality of determination elements. Here, the use of the moving velocity and the position of the user is exemplified, but the authentication difficulty degree may be determined by combining the determination elements described in the following example embodiments.

### Fourth Example Embodiment

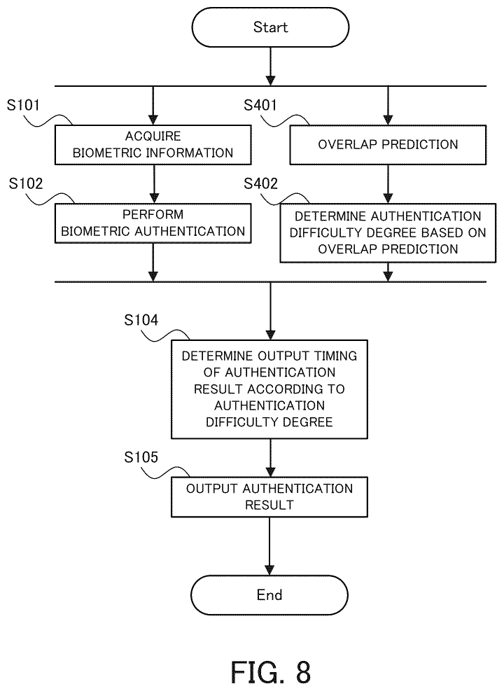

The information processing apparatus 10 according to the fourth example embodiment will be described with reference to FIG. 8. The fourth example embodiment describes a specific example of the determination element as in the second and third example embodiments, and may be the same as the first to third example embodiments in the other parts. For this reason, a part that is different from each of the example embodiments described above will be described in detail below, and a description of the other overlapping parts will be omitted as appropriate.

### (Flow of Operation)

First, with reference to FIG. 8, a flow of overall operation by the information processing apparatus 10 according to the fourth example embodiment will be described. FIG. 8 is a flowchart illustrating the flow of the operation of the information processing apparatus according to the fourth example embodiment. In FIG. 8, the same processing steps as those illustrated in FIG. 3 carry the same reference numerals.

As illustrated in FIG. 8, when the operation of the information processing apparatus 10 according to the fourth example embodiment starts, first, the biometric information acquisition unit 110 acquires the biometric information on the user located in the authentication area (step S101). Then, the authentication unit 120 performs the authentication processing by using the biometric information acquired by the biometric information acquisition unit 110 (step S102).

Meanwhile, the determination unit 130 predicts whether or not one user overlaps with another user, as the determination element for determining the authentication difficulty degree (step S401). That is, the determination unit 130 predicts whether or not one user is hidden in the shadow of another user, when viewed from the camera 20. For example, the determination unit 130 may determine whether or not one user overlaps with another user, based on the position, the moving velocity, a moving direction, or the like of one user and another user. A detailed description of a prediction method here will be omitted, as existing techniques/technologies may be employed as appropriate.

Subsequently, the determination unit 130 determines the authentication difficulty degree by using a prediction result regarding the overlap of the users (step S402). For example, the determination unit 130 may determine that the user who is predicted to overlap with another user, will be soon hidden by the other user and the biometric information cannot be acquired (in other words, a time of allowing the authentication is short), and may set a high authentication difficulty degree. The determination unit 130 may determine that it is possible to continue to acquire the biometric information on the user who is not predicted to overlap with another user for a while (in other words, a time of performing the authentication processing is long), and may set a low authentication difficulty degree.

Subsequently, the determination unit 140 determines the output timing of the authentication result, based on the authentication difficulty degree determined by the determination unit 130 (step S104). Then, the authentication unit 120 outputs the authentication result at the output timing determined by the determination unit 140 (step S105).

### (Technical Effect)

Next, a technical effect obtained by the information processing apparatus 10 according to the fourth example embodiment will be described.

As described in FIG. 8, in the information processing apparatus 10 according to the fourth example embodiment, the authentication difficulty degree is determined based on whether or not the user overlaps with another user. In this way, it is possible to identify the user who will be in a condition of being hardly authenticated in the future, thereby properly determining the authentication difficulty degree. Therefore, it is possible to output the authentication result at appropriate timing.

### Fifth Example Embodiment

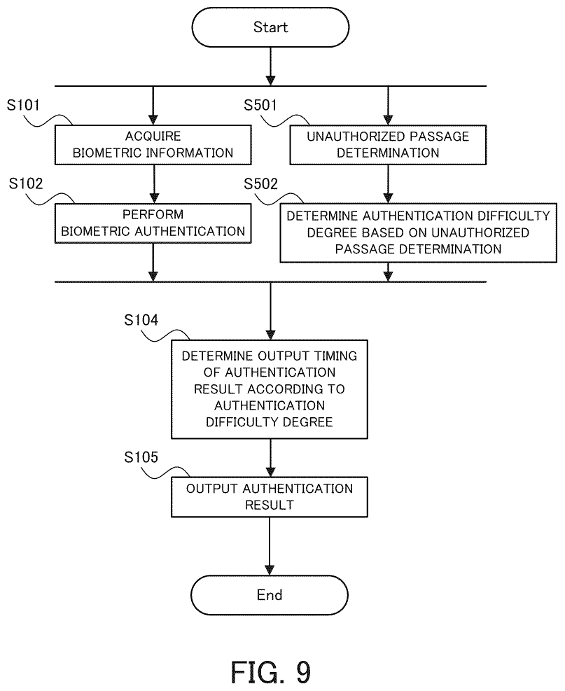

With reference to FIG. 9, the information processing apparatus 10 according to a fifth example embodiment will be described. The fifth example embodiment describes a specific example of the determination element as in the second to fourth example embodiments, and may be the same as the first to fourth example embodiments in the other parts. For this reason, a part that is different from each of the example embodiments described above will be described in detail below, and a description of the other overlapping parts will be omitted as appropriate.

### (Flow of Operation)

First, with reference to FIG. 9, a flow of overall operation by the information processing apparatus 10 according to the fifth example embodiment will be described. FIG. 9 is a flowchart illustrating the flow of the operation of the information processing apparatus according to the fifth example embodiment. In FIG. 9, the same processing steps as those illustrated in FIG. 3 carry the same reference numerals.

As illustrated in FIG. 9, when the operation of the information processing apparatus 10 according to the fifth example embodiment starts, first, the biometric information acquisition unit 110 acquires the biometric information on the user located in the authentication area (step S101). Then, the authentication unit 120 performs the authentication processing by using the biometric information acquired by the biometric information acquisition unit 110 (step S102).

Meanwhile, the determination unit 130 determines whether or not the user is intentionally attempting to avoid the authentication processing, as the determination element for determining the authentication difficulty degree (step S501). For example, the determination unit 130 may determine that the user is intentionally attempting to avoid the authentication processing (i.e., is attempting to unauthorizedly pass through) when it is determined that the user is hiding the face by both hands, that the user is not exposing the face by using a mask and sunglasses, or that the user is walking backward.

Subsequently, the determination unit 130 determines the authentication difficulty degree by using a prediction result of the unauthorized passage (step S502). For example, the determination unit 130 may determine that the user attempting to unauthorizedly pass through, is intentionally making a condition of being hardly authenticated, and may set a high authentication difficulty degree. Alternatively, the determination unit 130 may set a high authentication difficulty degree from the viewpoint of preventing the unauthorized passage as well as the viewpoint of the authentication difficulty degree. That is, for the user attempting to unauthorizedly pass through, the authentication result (alert) may be determined to be outputted early, and the authentication difficulty degree may be set high such that the output timing is early.

Subsequently, the determination unit 140 determines the output timing of the authentication result, based on the authentication difficulty degree determined by the determination unit 130 (step S104). Then, the authentication unit 120 outputs the authentication result at the output timing determined by the determination unit 140 (step S105).

### (Technical Effect)

Next, a technical effect obtained by the information processing apparatus 10 according to the fifth example embodiment will be described.

As described in FIG. 9, in the information processing apparatus 10 according to the fifth example embodiment, the authentication difficulty degree is determined based on whether or not the user is intentionally attempting to avoid the authentication processing. In this way, it is possible to identify the user attempting to unauthorizedly/illegally break the authentication processing, thereby properly determining the authentication difficulty degree. Therefore, it is possible to output the authentication result at appropriate timing.

### Sixth Example Embodiment

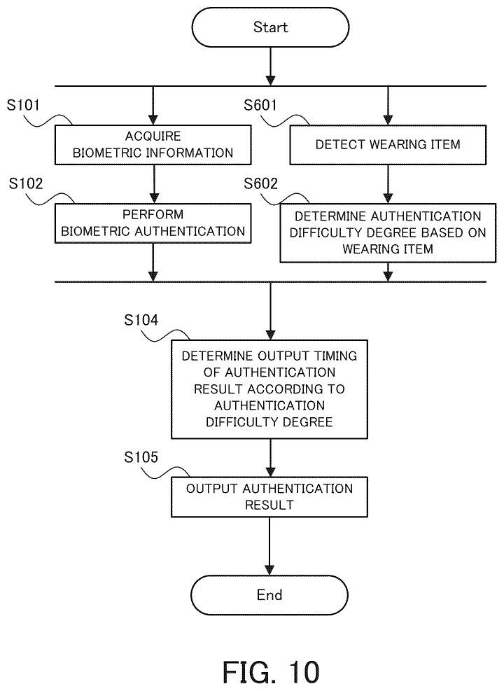

The information processing apparatus 10 according to a sixth example embodiment will be described with reference to FIG. 10. The sixth example embodiment describes a specific example of the determination element as in the second to fifth example embodiments, and may be the same as the first to fifth example embodiments in the other parts. For this reason, a part that is different from each of the example embodiments described above will be described in detail below, and a description of the other overlapping parts will be omitted as appropriate.

### (Flow of Operation)

First, with reference to FIG. 10, a flow of overall operation by the information processing apparatus 10 according to the sixth example embodiment will be described. FIG. 10 is a flowchart illustrating the flow of the operation of the information processing apparatus according to the sixth example embodiment. In FIG. 10, the same processing steps as those illustrated in FIG. 3 carry the same reference numerals.

As illustrated in FIG. 10, when the operation of the information processing apparatus 10 according to the sixth example embodiment starts, first, the biometric information acquisition unit 110 acquires the biometric information on the user located in the authentication area (step S101). Then, the authentication unit 120 performs the authentication processing by using the biometric information acquired by the biometric information acquisition unit 110 (step S102).

Meanwhile, the determination unit 130 acquires a wearing item of the user, as the determination element for determining the authentication difficulty degree (step 601). For example, the determination unit 130 may acquire information about a mask, sunglasses, a full-face helmet or the like worn by the user, from the image captured by the camera 20. The wearing item mentioned here is one example, and the wearing item that affects the authentication difficulty may be detected as appropriate.

Subsequently, the determination unit 130 determines the authentication difficulty degree by using the acquired information about the wearing item of the user (step S602). For example, the determination unit 130 may determine that it is hard to acquire the feature quantity about the face (in other words, it is hard to normally perform the face authentication) of the user wearing the mask or the sunglasses, and may a high set authentication difficulty degree. The determination unit 130 may also determine that it is easy to acquire the feature quantity about the face (in other words, the face authentication can be normally performed) of the user not wearing the mask or the sunglasses, and may set a low authentication difficulty degree.

Subsequently, the determination unit 140 determines the output timing of the authentication result, based on the authentication difficulty degree determined by the determination unit 130 (step S104). Then, the authentication unit 120 outputs the authentication result at the output timing determined by the determination unit 140 (step S105).

### (Technical Effect)

Next, a technical effect obtained by the information processing apparatus 10 according to the sixth example embodiment will be described.

As described in FIG. 10, in the information processing apparatus 10 according to the sixth example embodiment, the authentication difficulty degree is determined based on the wearing item of the user. In this way, it is possible to recognize that it is hard to perform the authentication due to the wearing item and to properly determine the authentication difficulty degree. Therefore, it is possible to output the authentication result at appropriate timing.

### Seventh Example Embodiment

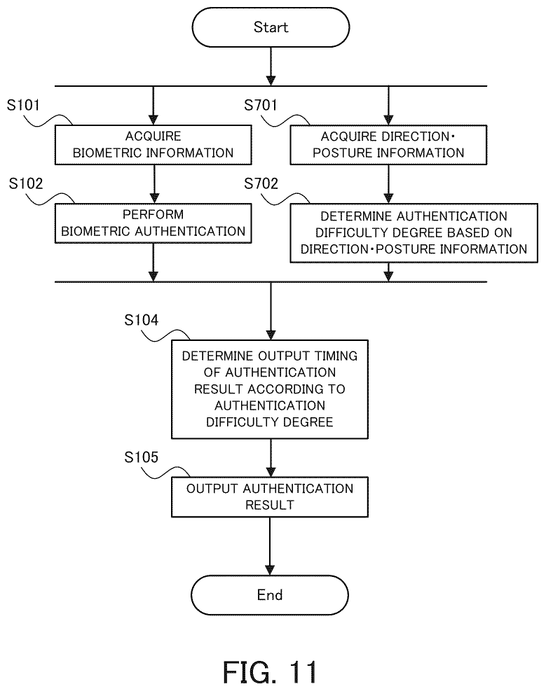

With reference to FIG. 11, the information processing apparatus 10 according to a seventh example embodiment will be described. The seventh example embodiment describes a specific example of the determination element as in the second to sixth example embodiments, and may be the same as the first to sixth example embodiments in the the other parts. For this reason, a part that is different from each of the example embodiments described above will be described in detail below, and a description of the other overlapping parts will be omitted as appropriate.

### (Flow of Operation)

First, with reference to FIG. 11, a flow of overall operation by the information processing apparatus 10 according to the seventh example embodiment will be described. FIG. 11 is a flowchart illustrating the flow of the operation of the information processing apparatus according to the seventh example embodiment. In FIG. 11, the same processing steps as those illustrated in FIG. 3 carry the same reference numerals.

As illustrated in FIG. 11, when the operation of the information processing apparatus 10 according to the seventh example embodiment starts, first, the biometric information acquisition unit 110 acquires the biometric information on the user located in the authentication area (step S101). Then, the authentication unit 120 performs the authentication processing by using the biometric information acquired by the biometric information acquisition unit 110 (step S102).

On the other hand, the determination unit 130 acquires information about at least one of a face direction, a posture, and a moving direction of the user, as the determination element for determining the authentication difficulty degree (step 701). For example, the determination unit 130 may acquire the face direction, the posture, and the moving direction of the user, from the image captured by the camera 20. Alternatively, the determination unit 130 may acquire the face direction, the posture, and the moving direction of the user, by using various sensors or the like different from the camera 20.

Subsequently, the determination unit 130 determines the authentication difficulty degree by using the acquired information about at least one of the face direction, the posture, and the moving direction of the user (step S702). For example, the determination unit 130 may determine that it is hard to acquire the feature quantity of the face of the user (in other words, it is hard to normally perform the biometric authentication) and may set a high authentication difficulty degree, when the user's face does not face the front (i.e., in a direction of the camera 20), when the face is hardly seen from the camera 20 due to the posture of the user (e.g., because the user is leaning forward), or when the moving direction of the user is not a direction toward the camera 20. In a case where the moving direction of the user is different from an assumed direction (e.g., in a case where it is not in a direction to the restricted area), however, the determination unit 130 may determine that this user is determined to be the user who does not intend to enter the restricted area (in other words, the alert does not need to be outputted even if the user cannot be authenticated), and may set a low authentication difficulty degree.

Subsequently, the determination unit 140 determines the output timing of the authentication result, based on the authentication difficulty degree determined by the determination unit 130 (step S104). Then, the authentication unit 120 outputs the authentication result at the output timing determined by the determination unit 140 (step S105).

### (Technical Effect)

Next, a technical effect obtained by the information processing apparatus 10 according to the seventh example embodiment will be described.

As described in FIG. 11, in the information processing apparatus 10 according to the seventh example embodiment, the authentication difficulty degree is determined based on at least one of the face direction, the posture, and the moving direction of the user. In this way, it is possible to identify the user who is in a condition of being hardly authenticated, or the user who does not necessarily need to be authenticated, thereby properly determining the authentication difficulty degree. Therefore, it is possible to output the authentication result at appropriate timing.

### Eighth Example Embodiment

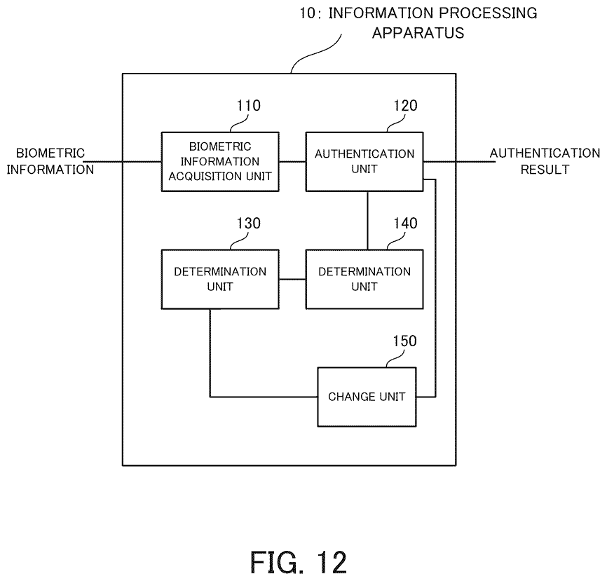

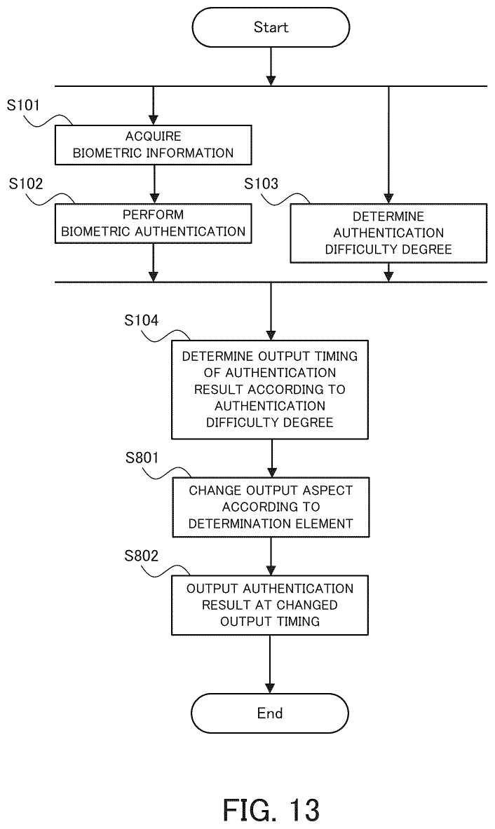

The information processing apparatus 10 according to an eighth example embodiment will be described with reference to FIG. 12 and FIG. 13. The eighth example embodiment is partially different from the first to seventh example embodiments only in the configuration and operation, and may be the same as the first to seventh example embodiments in the other parts. For this reason, a part that is different from each of the example embodiments described above will be described in detail below, and a description of the other overlapping parts will be omitted as appropriate.

### (Functional Configuration)

First, with reference to FIG. 12, a functional configuration of the information processing apparatus 10 according to the eighth example embodiment will be described. FIG. 12 is a block diagram illustrating the functional configuration of the information processing apparatus according to the eighth example embodiment. In FIG. 12, the same components as those illustrated in FIG. 2 carry the same reference numerals.

As illustrated in FIG. 12, the information processing apparatus 10 according to the eighth example embodiment includes, as components for realizing the functions thereof, the biometric information acquisition unit 110, the authentication unit 120, the determination unit 130, the determination unit 140, and a change unit 150. That is, the information processing apparatus 10 according to the eighth example embodiment further include the change unit 150 in addition to the configuration in the first example embodiment (see FIG. 2). The change unit 150 may be a processing block realized or implemented by the processor 11 (see FIG. 1), for example.

The change unit 150 is configured to change an output aspect of the authentication result in accordance with a type of the determination element of the authentication difficulty degree in the determination unit 130. For example, the change unit 150 may change the output aspect of the authentication result, in a case where the determination unit 130 determines the authentication difficulty degree by using the moving velocity of the user and in a case where the authentication difficulty degree is determined by using the position of user. In addition, in a case where the determination unit 130 determines the authentication difficulty degree by using a plurality of determination elements, the change unit 150 may change the output aspect of the authentication result when all of the determination elements are different, or may change the output aspect of the authentication result when a part of the determination elements is different. For example, in a case where the determination unit 130 determines the authentication difficulty degree by using the moving velocity and the position of the user and in a case where the authentication difficulty degree is determined by using the moving velocity and the wearing item of the user, a point that the moving velocity of the user is used as the determination element is common, but the other determination elements are not common. In such a case, it may be determined that all of the determination elements are not different and the output aspect may not be changed, or it may be determined that a part of the determination elements is different and the output aspect may be changed.

In changing the output aspect, the change unit 150 may change a color, a size, a shape, a degree of enhancement, or the like when displaying the authentication result. Alternatively, the change unit 150 may change loudness, tone, or the like of a sound when outputting the authentication result. The change unit 150 may change the output aspect of the authentication result to the one corresponding to the determination element. For example, when the determination element is a result of determination of the unauthorized passage of the user (see the fifth example embodiment), the change unit 150 may determine that this user is the user to whom more attention should be paid, and may change the output aspect to be a more emphasized one (e.g., conspicuous color, large display, blinking display, a loud sound, etc.).

### (Flow of Operation)

Referring now to FIG. 13, a flow of overall operation by the information processing apparatus 10 according to the eighth example embodiment will be described. FIG. 13 is a flowchart illustrating the flow of the operation of the information processing apparatus according to the eighth example embodiment. In FIG. 13, the same processing steps as those illustrated in FIG. 3 carry the same reference numerals.

As illustrated in FIG. 13, when the operation of the information processing apparatus 10 according to the eighth example embodiment starts, first, the biometric information acquisition unit 110 acquires the biometric information on the user located in the authentication area (step S101). Then, the authentication unit 120 performs the authentication processing by using the biometric information acquired by the biometric information acquisition unit 110 (step S102). Meanwhile, the determination unit 130 determines the authentication difficulty degree (step S103). Information about the determination element used when the determination unit 13 determines the authentication difficulty degree, is outputted to the change unit 150.

Subsequently, the determination unit 140 determines the output timing of the authentication result, based on the authentication difficulty degree determined by the determination unit 130 (step S104). Especially in the present example embodiment, the change unit 150 changes the output aspect of the authentication result, based on the determination element used by the determination unit 130 (step S801). Then the authentication unit 120 outputs the authentication result at the output timing determined by the determination unit 140 and in the output aspect changed by the change unit 150 (step S802).

### (Technical Effect)

Next, a technical effect obtained by the information processing apparatus 10 according to the eighth example embodiment will be described.

As described in FIG. 12 and FIG. 13, in the information processing apparatus 10 according to the eighth example embodiment, the output aspect of the authentication result is changed in accordance with the type of the determination element. In this way, it is possible to make a person recognize an importance of the authentication result depending on a difference in the output aspect. For example, when it can be determined from the type of the determination element that attention should be paid to the user, the authentication result is outputted to an observer/monitoring person or the like at an output destination in an appropriate output aspect, and it is thus possible to make the observer who receives the authentication result, easily recognize the importance of the authentication result.

### Ninth Example Embodiment

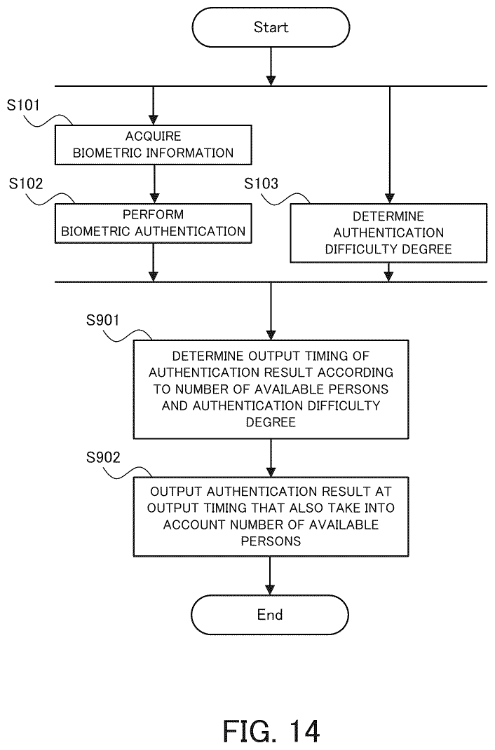

The information processing apparatus 10 according to a ninth example embodiment will be described with reference to FIG. 14. The ninth example embodiment is partially different from the first to eighth example embodiments only in the operation, and may be the same as the first to eighth example embodiments in the other parts. For this reason, a part that is different from each of the example embodiments described above will be described in detail below, and a description of the other overlapping parts will be omitted as appropriate.

### (Flow of Operation)

First, with reference to FIG. 14, a flow of overall operation by the information processing apparatus 10 according to the ninth example embodiment will be described. FIG. 14 is a flowchart illustrating the flow of the operation of the information processing apparatus according to the ninth example embodiment. In FIG. 14, the same processing steps as those illustrated in FIG. 3 carry the same reference numerals.

As illustrated in FIG. 14, when the operation of the information processing apparatus 10 according to the ninth example embodiment is started, first, the biometric information acquisition unit 110 acquires the biometric information on the user located in the authentication area (step S101). Then, the authentication unit 120 performs the authentication processing by using the biometric information acquired by the biometric information acquisition unit 110 (step S102). Meanwhile, the determination unit 130 determines the authentication difficulty degree (step S103). The information about the determination element used when the determination unit 13 determines the authentication difficulty degree, is outputted to the change unit 150.

Subsequently, the determination unit 140 determines the output timing of the authentication result, based on the authentication difficulty degree determined by the determination unit 130 and the number of available persons (step S901). That is, the determination unit 140 according to the present example embodiment determines the output timing of the authentication result in view of the number of available persons in addition to the authentication difficulty degree described in the example embodiments described above. The “number of available persons” here is the number of people (e.g., observers/monitoring person, etc.) who is able to handle or take care of the user reaching outside the authentication area without completing the authentication processing. The number of available persons may be the number set in advance (e.g., the number corresponding to attendance management information on a staff in a time zone), or a value that is outputted by detecting the observer who is actually able to handle the user at each time.

For example, when there are a relatively small number of available persons, the determination unit 140 may determine that it is hardly possible to respond to the users if many users to be handled are detected simultaneously, and may determine to delay the output timing of the authentication result. Furthermore, when there are a relatively large number of available persons, the determination unit 140 may determine that it is possible to respond to the users the number of corresponding users can be detected at the same time even if many users to be handled are detected simultaneously, and may determine to advance the output timing of the authentication result. Thereafter, the authentication unit 120 outputs the authentication result at the output timing determined by the determination unit 140 (i.e., the output timing determined based on the authentication difficulty degree and the number of available persons) (step S902).

### (Technical Effect)

Next, a technical effect obtained by the information processing apparatus 10 according to the ninth example embodiment will be described.

As described in FIG. 14, in the information processing apparatus 10 according to the ninth example embodiment, the output timing of the authentication result is determined in accordance with the number of available persons in addition to the authentication difficulty degree. In this way, it is possible to output the authentication result at more appropriate timing, in comparison with a case where only the authentication difficulty degree is used.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### <Supplementary Notes>

The example embodiments described above may be further described as, but not limited to, the following Supplementary Notes below.

### (Supplementary Note 1)

An information processing apparatus according to Supplementary Note 1 is an information processing apparatus including: an acquisition unit that acquires biometric information on a user located in an authentication area; an authentication unit that performs authentication processing based on the biometric information; an authentication difficulty degree determination unit that determines an authentication difficulty degree indicating a possibility that the user reaches outside the authentication area without completing the authentication processing; and an output timing determination unit that determines output timing of a result of the authentication processing in accordance with the authentication difficulty degree.

### (Supplementary Note 2)

An information processing apparatus according to Supplementary Note 2 is the information processing apparatus according to Supplementary Note 1, wherein the authentication difficulty degree determination unit determines the authentication difficulty degree, based on a moving velocity of the user.

### (Supplementary Note 3)

An information processing apparatus according to Supplementary Note 3 is the information processing apparatus according to Supplementary Note 1 or 2, wherein the authentication difficulty degree determination unit determines the authentication difficulty degree, based on a position of the user.

### (Supplementary Note 4)

An information processing apparatus according to Supplementary Note 4 is the information processing apparatus according to any one of Supplementary Notes 1 to 3, wherein the authentication difficulty degree determination unit determines the authentication difficulty degree, based on whether or not it is predicted that the user overlaps with another user, when viewed from a sensor that acquires the biometric information.

### (Supplementary Note 5)

An information processing apparatus according to Supplementary Note 5 is the information processing apparatus according to any one of Supplementary Notes 1 to 4, wherein the authentication difficulty degree determination unit determines the authentication difficulty degree, based on whether or not the user is intentionally attempting to avoid the authentication processing.

### (Supplementary Note 6)

An information processing apparatus according to Supplementary Note 6 is the information processing apparatus according to any one of Supplementary Notes 1 to 5, wherein the authentication difficulty degree determination unit determines the authentication difficulty degree, based on a wearing item of the user.

### (Supplementary Note 7)

An information processing apparatus according to Supplementary Note 7 is the information processing apparatus according to any one of Supplementary Notes 1 to 6, wherein the authentication difficulty degree determination unit determines the authentication difficulty degree, based on at least one of a face direction, a posture, and a moving direction of the user.

### (Supplementary Note 8)

An information processing apparatus according to Supplementary Note 8 is the information processing apparatus according to any one of Supplementary Notes 1 to 7, further including a change unit that changes an output aspect of the result of the authentication processing in accordance with a type of a determination element of the authentication difficulty degree in the authentication difficulty degree determination unit.

### (Supplementary Note 9)

An information processing apparatus according to Supplementary Note 9 is the information processing apparatus according to any one of Supplementary Notes 1 to 8, wherein the output timing determination unit determines the output timing of the result of the authentication processing in accordance with a number of persons who are able to handle a user reaching outside the authentication area without completing the authentication processing, in addition to the authentication difficulty degree.

### (Supplementary Note 10)

An information processing system according to Supplementary Note 10 is an information processing system including: an acquisition unit that acquires biometric information on a user located in an authentication area; an authentication unit that performs authentication processing based on the biometric information; an authentication difficulty degree determination unit that determines an authentication difficulty degree indicating a possibility that the user reaches outside the authentication area without completing the authentication processing; and an output timing determination unit that determines output timing of a result of the authentication processing in accordance with the authentication difficulty degree.

### (Supplementary Note 11)

An information processing method according to Supplementary Note 11 is an information processing method that is executed by at least one computer, the information processing method including: acquiring biometric information on a user located in an authentication area; performing authentication processing based on the biometric information; determining an authentication difficulty degree indicating a possibility that the user reaches outside the authentication area without completing the authentication processing; and determining output timing of a result of the authentication processing in accordance with the authentication difficulty degree.

### (Supplementary Note 12)

A recording medium according to Supplementary Note 12 is a recording medium on which a computer program that allows at least one computer to execute an information processing method is recorded, the information processing method including: acquiring biometric information on a user located in an authentication area; performing authentication processing based on the biometric information; determining an authentication difficulty degree indicating a possibility that the user reaches outside the authentication area without completing the authentication processing; and determining output timing of a result of the authentication processing in accordance with the authentication difficulty degree.

### (Supplementary Note 13)

A computer program according to Supplementary Note 13 is a computer program that allows at least one computer to execute an information processing method, the information processing method including: acquiring biometric information on a user located in an authentication area; performing authentication processing based on the biometric information; determining an authentication difficulty degree indicating a possibility that the user reaches outside the authentication area without completing the authentication processing; and determining output timing of a result of the authentication processing in accordance with the authentication difficulty degree.

This disclosure is allowed to be changed, if desired, without departing from the essence or spirit of this disclosure which can be read from the claims and the entire specification. An information processing apparatus, an information processing system, an information processing method, and a recording medium with such changes are also intended to be within the technical scope of this disclosure.

### DESCRIPTION OF REFERENCE CODES

10 Information processing apparatus
11 Processor
110 Biometric information acquisition unit
120 Authentication unit
130 Determination unit
140 Determination unit
150 Change unit

What is claimed is:

1. An information processing apparatus comprising:
at least one memory that is configured to store instructions; and
at least one processor that is configured to execute the instructions to:
acquire biometric information on a user located in an authentication area;
perform authentication processing based on the biometric information;
determine an authentication difficulty degree indicating a possibility that the user reaches outside the authentication area without completing the authentication processing; and
determine output timing of a result of the authentication processing in accordance with the authentication difficulty degree.

2. The information processing apparatus according to claim 1, wherein the at least one processor that is configured to execute the instructions to determine the authentication difficulty degree, based on a moving speed of the user.

3. The information processing apparatus according to claim 1, wherein the at least one processor that is configured to execute the instructions to determine the authentication difficulty degree, based on a position of the user.

4. The information processing apparatus according to claim 1, wherein the at least one processor that is configured to execute the instructions to determine the authentication difficulty degree, based on whether or not it is predicted that the user overlaps with another user, in a case where viewed from a sensor that acquires the biometric information.

5. The information processing apparatus according to claim 1, wherein the at least one processor that is configured to execute the instructions to determine the authentication difficulty degree, based on whether or not the user is intentionally attempting to avoid the authentication processing.

6. The information processing apparatus according to claim 1, wherein the at least one processor that is configured to execute the instructions to determine the authentication difficulty degree, based on a wearing item of the user.

7. The information processing apparatus according to claim 1, wherein the at least one processor that is configured to execute the instructions to determine the authentication difficulty degree, based on at least one of a face direction, a posture, and a moving direction of the user.

8. The information processing apparatus according to claim 1, wherein the at least one processor that is configured to execute the instructions to change an output aspect of the result of the authentication processing in accordance with a type of a determination element of the authentication difficulty degree.

9. The information processing apparatus according to claim 1, wherein the at least one processor that is configured to execute the instructions to determine the output timing of the result of the authentication processing in accordance with a number of persons who are able to handle a user reaching outside the authentication area without completing the authentication processing, in addition to the authentication difficulty degree.

10. (canceled)

11. An information processing method that is executed by at least one computer, the information processing method comprising:
acquiring biometric information on a user located in an authentication area;
performing authentication processing based on the biometric information;
determining an authentication difficulty degree indicating a possibility that the user reaches outside the authentication area without completing the authentication processing; and
determining output timing of a result of the authentication processing in accordance with the authentication difficulty degree.

12. A non-transitory recording medium on which a computer program that allows at least one computer to execute an information processing method is recorded, the information processing method including:
acquiring biometric information on a user located in an authentication area;
performing authentication processing based on the biometric information;
determining an authentication difficulty degree indicating a possibility that the user reaches outside the authentication area without completing the authentication processing; and
determining output timing of a result of the authentication processing in accordance with the authentication difficulty degree.
